(19) United States
(12) Patent Application Publication
(10) Pub. No.: US 2011/0189517 A1
(43) Pub. Date: Aug. 4, 2011

(54) ALKALINE BATTERY

(76) Inventors: Fumio Kato, Osaka (JP); Jun Nunome, Kyoto (JP); Harunari Shimamura, Osaka (JP)

(21) Appl. No.: 13/122,527

(22) PCT Filed: Sep. 14, 2009
(86) PCT No.: PCT/JP2009/004577

§ 371 Date: Apr. 4, 2011

(30) Foreign Application Priority Data
Nov. 21, 2008 (JP) 2008-298466

(51) Int. Cl. H01M 6/10; H01M 2/02

(52) U.S. Cl. 429/94; 429/164

(57) ABSTRACT

An alkaline battery is provided in which the pulse discharge characteristic under high load is improved with a stable performance for drop impact or vibration. The alkaline battery includes a hollow cylindrical positive electrode 2 placed in a cylindrical battery case 8 having a closed bottom, a negative electrode 3 placed in a hollow part of the positive electrode 2, a separator 4 arranged between the positive electrode 2 and the negative electrode 3, and an alkaline electrolyte, wherein the negative electrode 3 includes a hollow cylindrical skeleton part 11 made of a porous zinc body, and a gel part 12 which is placed in a hollow part of the skeleton part 11, and is made of zinc particles and a gelled electrolyte, and a current collector pin 6 made of metal is inserted in the gel part 12.

### TECHNICAL FIELD

The present invention relates to alkaline batteries.

### BACKGROUND ART

Alkaline batteries (alkali-manganese dry batteries) including a manganese dioxide positive electrode, a zinc negative electrode, and an aqueous alkaline solution as an electrolyte are adaptable to a wide variety of applications, and are inexpensive. For these reasons, the alkaline batteries have widely been and are being used as power sources of various devices.

In some commercially available alkaline batteries, a negative electrode made of zinc gel obtained by dispersing zinc powder in a gelled alkaline electrolyte dissolving a gelled component (polyacrylic acid etc.) is employed. In the negative electrode containing the zinc gel, electrical bonding/contact among particles of the zinc powder (conductive network) is insufficient, and ion conductivity of the gelled alkaline electrolyte is low. Therefore, utilization ratio of zinc in the negative electrode using the zinc gel is likely to decrease in high rate discharge. To address the problem, PATENT DOCUMENTS 1 to 3 propose a technology of using a porous zinc body (in the form of a ribbon, wool, metal foam, etc.) as the negative electrode to improve the conductive network, and using an alkaline electrolyte which does not contain the gelled component, and has high ion conductivity to increase the zinc utilization ratio.

### Citiation List

### Patent Document

PATENT DOCUMENT 1: Japanese Translation of PCT International Application No. 2002-531923

PATENT DOCUMENT 2: Japanese Translation of PCT International Application No. 2008-518408

PATENT DOCUMENT 3: Japanese Patent Publication No. 2005-294225

### SUMMARY OF THE INVENTION

### Technical Problem

However, when a porous zinc body is used as a negative electrode of an alkaline battery, satisfactory current collection between the negative electrode and a terminal is difficult.

In order to use a porous zinc body as a negative electrode in a sealed alkaline battery in practical use, such a problem with current collection has to be solved.

### Solution to the Problem

In view of the foregoing, an alkaline battery of the present invention includes: a hollow cylindrical positive electrode placed in a cylindrical battery case having a closed bottom; a negative electrode placed in a hollow part of the positive electrode; a separator arranged between the positive electrode and the negative electrode; and an alkaline electrolyte, wherein the negative electrode includes a hollow cylindrical skeleton part made of a porous zinc body, and a gel part which is placed in a hollow part of the skeleton part, and is made of zinc particles and a gelled electrolyte, and a current collector pin made of metal is inserted in the gel part.

### ADVANTAGES OF THE INVENTION

The present invention can provide an alkaline battery which is improved in pulse discharge characteristic under high load and which provides stable performance for drop impact, vibration, etc.

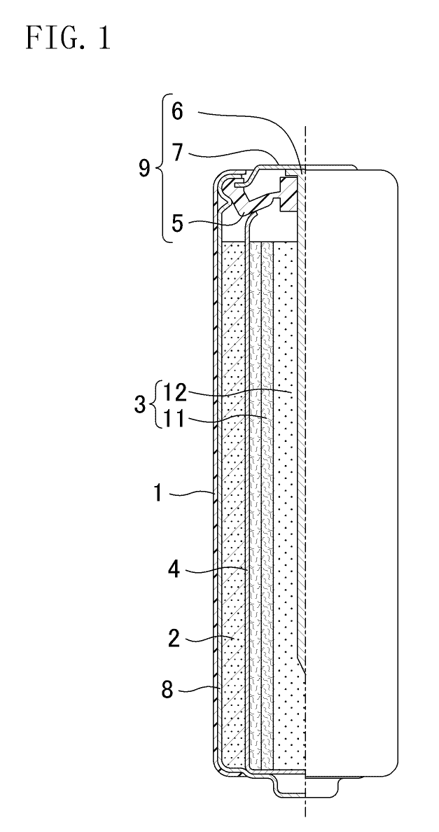

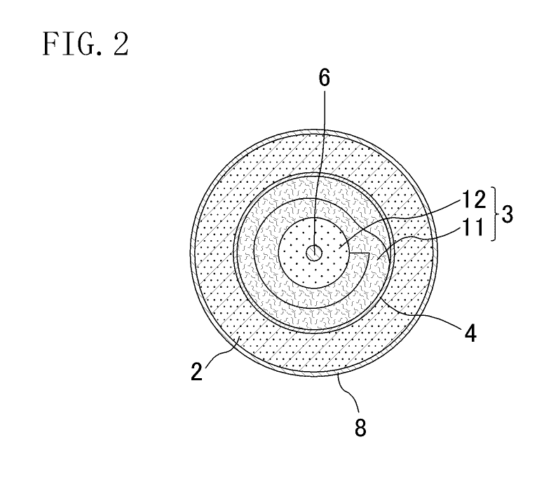

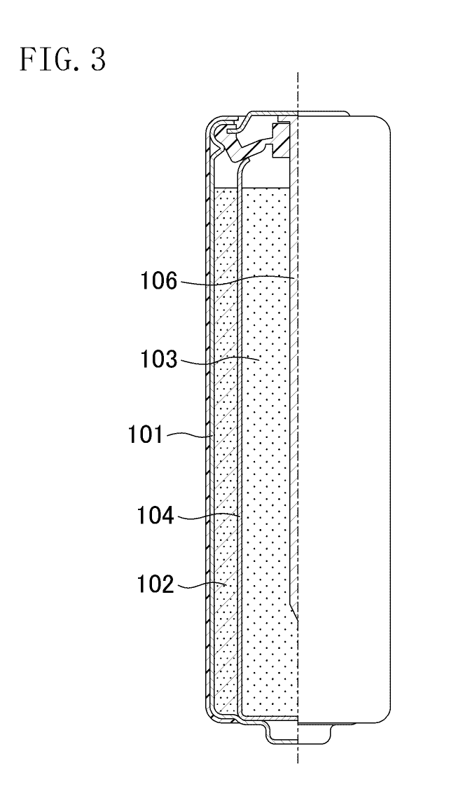

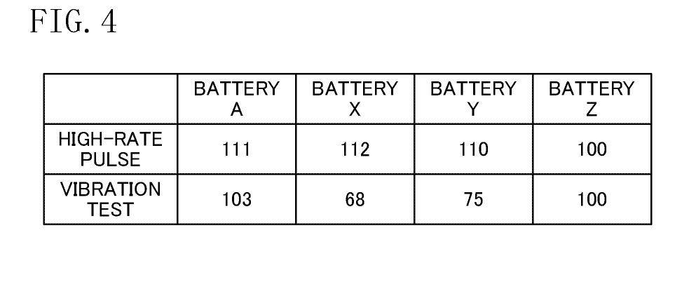

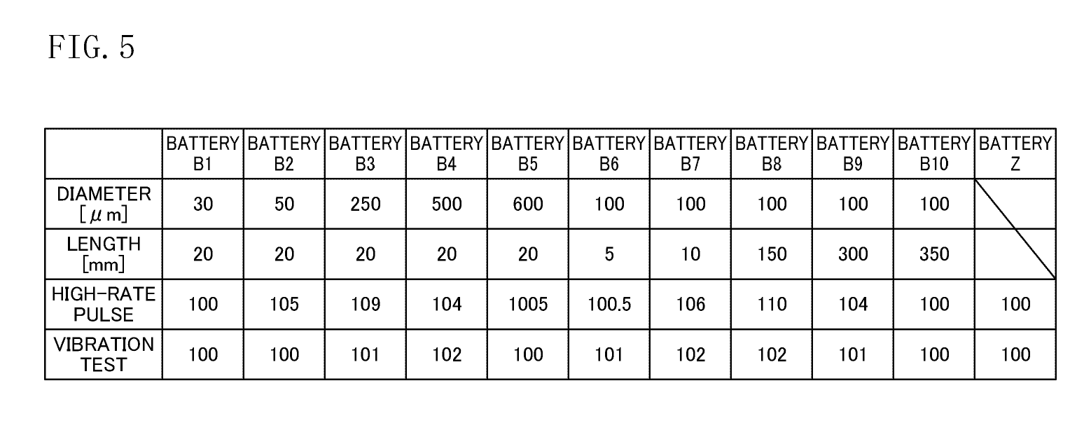

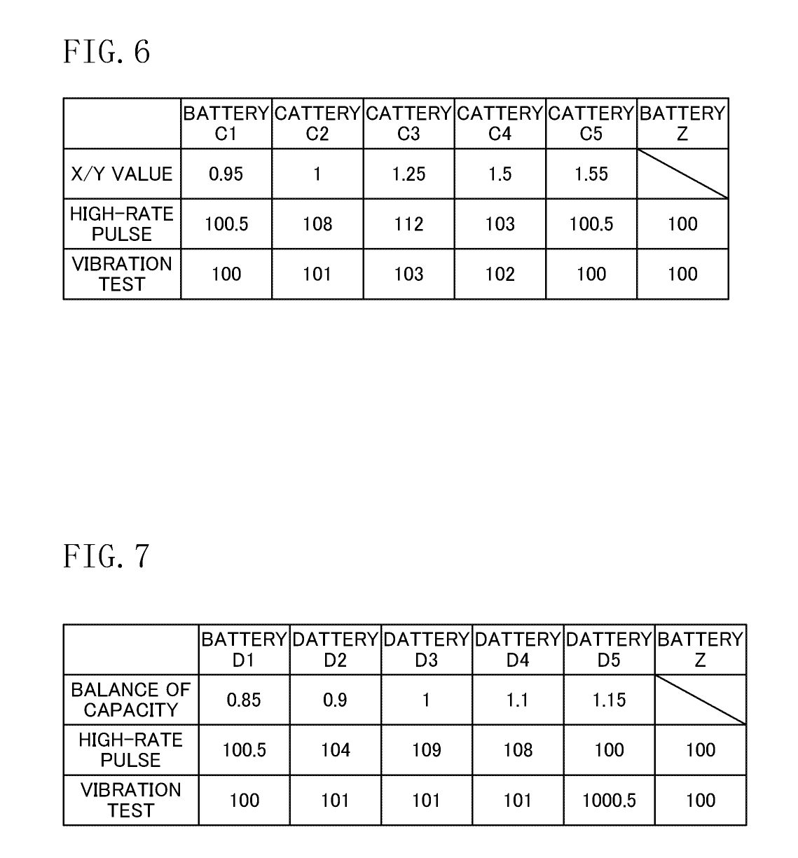

### BRIEF DESCRIPTION OF THE DRAWINGS

[FIG. 1] FIG. 1 is a front view illustrating an alkaline battery of an embodiment, partially cut away.

[FIG. 2] FIG. 2 is a cross sectional view schematically illustrating the alkaline battery of the embodiment.

[FIG. 3] FIG. 3 is a front view illustrating an alkaline battery, partially cut away, wherein zinc particles dispersed in gel is used as a negative electrode.

[FIG. 4] FIG. 4 is a table indicating discharge characteristics of dry batteries of a first example and first to third comparative examples.

[FIG. 5] FIG. 5 is a table indicating discharge characteristics of dry batteries of a second example and a third comparative example.

[FIG. 6] FIG. 6 is a table indicating discharge characteristics of dry batteries of a third example and the third comparative example.

[FIG. 7] FIG. 7 is a table indicating discharge characteristics of dry batteries of a fourth example and the third comparative example.

### DESCRIPTION OF EMBODIMENTS

Before the description of embodiments, the inventors' study will be described below.

An alkaline battery using zinc gel is configured as shown in FIG. 3. A hollow cylindrical positive electrode pellet 102 is placed in a battery case 101, and a negative electrode 103 is arranged inside the positive electrode pellet 102 with a separator 104 interposed therebetween. Such an alkaline battery includes a current collector pin 106 inserted in the negative electrode 103 to ensure current collection between the negative electrode 103 and a terminal. Even when a gap (resistance) is formed at an interface between the negative electrode 103 and the current collector pin 106 due to drop impact, vibration, etc. of the battery, current collection can sufficiently be ensured because the zinc gel has the advantage of flexibly moving to surround the current collector pin 106.

In contrast, when a like current collector pin is used to establish a connection to a porous zinc body negative electrode, it is, in the first place, difficult to ensure current collection in mass production of batteries. Moreover, the inventors of the present application found that even if the current collection is sufficiently ensured, when drop impact, vibration, etc. of the battery causes a gap or resistance at an interface between the negative electrode and the current collector pin, the performance is necessarily degraded because the porous body negative electrode does not have the function of alleviating the impact or the vibration to ensure the passage of an electric current. Note that PATENT DOCUMENT 1 and PATENT DOCUMENT 3 do not discuss these problems. Moreover, PATENT DOCUMENT 2 addresses only open batteries, and thus does not take the problem with current collection between the negative electrode and the terminal into consideration.

Alternatively, the porous zinc body negative electrode may use a current collection method other than connection using the current collector pin. In this case, the present inventors found the following problems.

(1) When it is attempted to ensure current collection by welding between a negative electrode lead and a sealing plate after formation of an electrode group, as is the case for other battery types, substances sputtered during the welding may enter the negative electrode or the positive electrode, which may cause excessive gas generation, leakage, or a micro short-circuit in the battery.

(2) When a sealing plate (assembled sealing body) is integrated with a negative electrode in advance, and the integrated member is placed in a battery case, an electrolyte injection process is very difficult.

As a result of the inventors' study to address the newly found problems, the inventors have achieved the present invention. Illustrative embodiments of the present invention will be described below.

### First Embodiment

An alkaline battery of a first embodiment includes a hollow cylindrical positive electrode placed in a cylindrical battery case having a closed bottom, a negative electrode placed in a hollow part of the positive electrode, a separator arranged between the positive electrode and the negative electrode, and an alkaline electrolyte, wherein the negative electrode includes a hollow cylindrical skeleton part made of a porous zinc body, and a gel part which is placed in a hollow part of the skeleton part, and is made of zinc particles and a gelled electrolyte, and a current collector pin made of metal is inserted in the gel part. The zinc particles used have an average particle diameter of 10 μm to 1000 μm, both inclusive, and can be fabricated by, for example, gas atomization.

To address the problems, the present inventors have conducted various studies, and have found that a discharge reaction (oxidation) of zinc in the alkaline battery proceeds from an outer circumference of the negative electrode facing the positive electrode toward the center of the negative electrode, and thus arranging the porous zinc body only at the outer circumference of the negative electrode can sufficiently improve conductive network at a reaction site, so that high discharge-performance can be obtained. The gel part made of the zinc particles and the gelled electrolyte is placed at the center of the negative electrode, and the current collector pin made of metal is inserted in the gel part to ensure current collection. With this configuration, even when a gap or resistance may be formed at an interface between the negative electrode and the current collector pin due to drop impact, vibration, etc. of the battery, the gel part moves along with the current collector pin to ensure current collection, so that it is possible to maintain stable performance.

In terms of the fabrication process of batteries, it is easy and preferable to form the skeleton part by winding a porous zinc sheet into a hollow cylindrical shape.

The porous zinc sheet is preferably made of an aggregate of zinc fibers each having a diameter of 50 μm to 500 μm, both inclusive, and a length of 10 mm to 300 mm, both inclusive. The porous zinc sheet is required to have a mechanical strength enough to keep the shape of the negative electrode, and a surface area enough to cause a smooth discharge reaction. When the diameter of the zinc fiber is controlled to 50 μm or more, and the length is controlled to 10 mm or more, the mechanical strength enough to keep the shape of the negative electrode can be obtained. When the diameter of the zinc fiber is controlled to 2000 μm or less, preferably 500 μm or less, and the length is controlled to 300 mm or less, the surface area required for the reaction can be ensured.

Zinc fibers can efficiently be formed by melt spinning at low cost. Melt spinning is a generic name for methods of producing thin threads from a metal melt in one step, and is more specifically classified into melt extrusion, in-rotating liquid spinning, melt extraction, jet quenching, etc. In the melt extrusion, a melt is extruded through a pore of a nozzle into a cooling fluid, and then is cooled, thereby producing a metal filament. In the in-rotating liquid spinning, a melt is sprayed in a stream of rotating water, and then is cooled, thereby producing a metal filament. In the melt extraction, a melt is extracted in a gas or in air, and then is cooled, thereby producing a metal filament. In the jet quenching, a melt is sprayed onto a rotating metal drum, and then is cooled, thereby producing a metal filament. Here, changing the diameter of the nozzle and conditions for spraying makes it possible to obtain a metal filament having a preferable diameter and a preferable length.

In the present embodiment, the battery is preferably designed in such a manner that the total mass ratio x/y of the alkaline electrolyte and the gelled electrolyte relative to zinc satisfies 1.0≦x/y≦1.5, where the total mass of the alkaline electrolyte and the gelled electrolyte contained in the battery is x [g], and the mass of zinc contained in the negative electrode is y [g]. The value x/y is generally set to be less than 1.0 for a common alkaline battery using only a gelled electrolyte as the alkaline electrolyte. This is because when the ratio of the alkaline electrolyte is high, electrical bonding/contact among the zinc powder particles in the negative electrode (conductive network) is insufficient, or sedimentation of the zinc powder may occur. However, in the present embodiment, since the outer circumference of the negative electrode is provided with the skeleton part made of the porous zinc body, the optimum range of the value x/y is changed. When the battery is designed to satisfy 1.0≦x/y, a sufficient amount of the electrolyte necessary for the discharge reaction of the zinc negative electrode can be supplied, and the utilization ratio of the negative electrode can be improved. When the battery is designed to satisfy x/y≦1.5, a necessary and sufficient amount of zinc can be contained in the battery, thereby providing the alkaline battery with high capacity.

In the present embodiment, balance of capacity between the negative electrode and the positive electrode, which is calculated on the conditions that MnO₂ contained in the positive electrode has a theoretical capacity of 308 mAh/g, and Zn contained in the negative electrode has a theoretical capacity of 820 mAh/g, is preferably 0.9 to 1.1, both inclusive. In the common alkaline battery including only a zinc gel, the balance of capacity between the negative electrode and the positive electrode is usually set to be higher than 1.1. This is because the utilization ratio of the zinc gel negative electrode is extremely low as compared with the utilization ratio of the positive electrode, and the zinc gel negative electrode has to be contained in the battery in an amount excessively greater than the theoretical amount. However, the utilization ratio of the negative electrode of the present embodiment is higher than that of the conventional negative electrode. Thus, the balance of capacity between the negative electrode and the positive electrode can be set to be 1.1 or lower, so that the amount of the positive electrode material in the battery can be increased as compared with that in the conventional battery, thereby increasing the capacity of the battery. When the balance of capacity between the negative electrode and the positive electrode is set to 0.9 or higher, a necessary and sufficient amount of zinc can be contained in the battery, thereby increasing the capacity of the alkaline battery.

—Description of Alkaline Battery—

An alkaline battery of a first embodiment will be described with reference to FIGS. 1 and 2.

As illustrated in FIG. 1, the alkaline battery of the first embodiment includes a positive electrode made of a hollow cylindrical positive electrode material mixture pellet 2, and a negative electrode 3 including a skeleton part 11 and a gel part 12. The positive electrode material mixture pellet 2 and the negative electrode 3 are isolated by a separator 4. The skeleton part 11 is, as illustrated in FIG. 2, formed by winding a porous zinc sheet. The gel part 12 is formed by dispersing zinc powder (zinc particles) in a gelled electrolyte. A cylindrical battery case 8 having a closed bottom is made of a nickel-plated steel sheet. A graphite coating is formed inside the battery case 8.

The alkaline battery shown in FIG. 1 can be produced in the following manner. Specifically, a plurality of hollow cylindrical positive electrode material mixture pellets (a positive electrode) 2 containing a positive electrode active material, such as manganese dioxide etc., are placed in the battery case 8, and are pressed to be close contact with an inner surface of the battery case 8.

A wound columnar separator 4 and an insulating cap are placed inside the positive electrode material mixture pellet 2, and then, the skeleton part 11 of the negative electrode 3 is placed inside the separator 4. The skeleton part 11 is produced in advance by winding a sheet of a porous zinc body made of a negative electrode active material into a hollow cylindrical shape. The porous zinc sheet is formed by compressing zinc fibers each having a diameter of 50 μm to 500 μm, both inclusive, and a length of 10 mm to 300 mm, both inclusive.

Then, an electrolyte is injected to wet the separator 4, the positive electrode material mixture pellet 2, and the skeleton part 11. The alkaline electrolyte is made of a potassium hydroxide aqueous solution, to which an anionic surfactant, and a quaternary ammonium salt-based cationic surfactant are added, and an indium compound, a bismuth compound, a tin compound, etc. are added as needed.

Next, the gel part 12 is placed in a hollow part of the skeleton part 11. Then, a negative electrode terminal structure 9 obtained by integrating a resin sealing plate 5, a bottom plate 7 also serving as negative electrode terminal, and a current collector pin 6 is inserted in an opening end of the battery case 8. Here, the current collector pin 6 is fitted in the gel part 12, thereby electrically connecting the negative electrode 3 to the bottom plate 7. The opening end of the battery case 8 is clamped onto a rim of the bottom plate 7 with a rim of the sealing plate 5 interposed therebetween, thereby bringing the opening end of the battery case 8 into close contact with the bottom plate with the sealing plate interposed therebetween.

Lastly, an outer surface of the battery case 8 is coated with an outer label 1. Thus, the alkaline battery of the present embodiment is obtained.

Examples of the present invention will be described in detail below. The present invention is not limited to the following examples.

### EXAMPLES

### First Example

—Production of Positive Electrode—

A positive electrode was produced in the following manner. Electrolytic manganese dioxide and graphite were mixed in the weight ratio of 94:6. To the mixed powder, 1 part by weight (pbw) of an electrolyte (a 39 weight percent (wt. %) potassium hydroxide aqueous solution containing 2 wt. % of ZnO) relative to 100 pbw of the mixed powder was mixed, and the mixture was uniformly stirred and mixed with a mixer to granulate the mixture into a certain size. The obtained granules were press-molded using a hollow cylindrical mold, thereby producing a positive electrode material mixture pellet. Electrolytic manganese dioxide used was HH-TF manufactured by Tosoh Corporation, and graphite used was SP-20 manufactured by Nippon Graphite Industries, ltd.

—Production of Negative Electrode—

(1) Skeleton Part

Zinc fibers obtained by melt spinning (average diameter: 100 μm, average length: 20 mm, manufactured by Akao Aluminum Co., Ltd.) were compressed using a platen press, thereby obtaining nonwoven fabric sheets. These zinc fiber sheets were porous zinc sheets each including gaps communicating with each other. Each of the zinc fiber sheets was cut into a rectangular shape of a predetermined dimension.

Next, around a columnar core, each of the zinc fiber sheets was wound like a jelly roll. After winding, the core was removed, thereby forming a hollow cylindrical skeleton part. An outer diameter of the skeleton part was smaller than an inner diameter of the positive electrode material mixture pellet by about 1 mm.

(2) Gel Part

Zinc particles (powder) (lot No. 70SA-H, containing 50 ppm of Al, 50 ppm of Bi, and 200 ppm of In) manufactured by Mitsui Mining & Smelting Co., Ltd. was prepared, where the zinc particles were obtained by gas atomization and by being classified using a vibration screen to have an average particle diameter of about 180 μm.

Then, to the zinc particles, 54 pbw of a 33 wt. % potassium hydroxide aqueous solution (containing 2 wt. % of ZnO) as a gelled alkaline electrolyte serving as a dispersion medium, 0.7 pbw of crosslinked polyacrylic acid, and 1.4 pbw of a crosslinked sodium polyacrylate relative to 100 pbw of the zinc particles were added and mixed. To the obtained mixture, 0.03 pbw of indium hydroxide (0.0197 pbw of indium metal) was further added and mixed, thereby preparing a material for the gel part.

—Assembly of Alkaline Battery—

The positive electrode material mixture pellet obtained as described above was inserted in the battery case made of a nickel-plated steel sheet to cover an inner wall surface of the battery case. Then, a separator was inserted. The separator used was Vinylon lyocell composite nonwoven fabric manufactured by Kuraray Co., Ltd.

The hollow cylindrical skeleton part was then inserted in a hollow part of the positive electrode material mixture pellet. The separator was interposed between the positive electrode and the skeleton part. Subsequently, to the separator and the skeleton part, a predetermined amount of a 33 wt. % potassium hydroxide aqueous solution (containing 2 wt. % of ZnO) was injected.

Then, the hollow part of the skeleton part was filled with the material for the gel part, thereby forming the gel part. A negative electrode terminal structure was placed such that a current collector pin was inserted in the gel part, and then a bottom plate was clamped to produce an alkaline battery A.

### First Comparative Example

Dry battery X of a first comparative example was produced in the same manner as the first example except that the wound columnar zinc fiber sheet was placed in the hollow part of the positive electrode of the alkaline battery without forming the gel part. That is, the negative electrode of the first comparative example includes only a zinc fiber sheet. A current collector pin was inserted in the wound columnar zinc fiber sheet at the center axis of the wound columnar zinc fiber sheet. The total amount of zinc and the mass of the electrolyte in the dry battery were the same as those of the first example.

### Second Comparative Example

Dry battery Y of a second comparative example was produced in the same manner as the first comparative example except that 0.8 mass % of polyacrylic acid serving as a gelling agent was added to the alkaline electrolyte of the alkaline battery.

### Third Comparative Example

Dry battery Z of a third comparative example was produced in the same manner as the first example except that a conventional gelled alkaline electrolyte in which zinc powder was dispersed (a material for the gel part) was used as the negative electrode, and no zinc fiber sheet was used. The mass of zinc and the mass of the alkaline electrolyte in the battery were the same as those of the first example.

—Evaluation of Discharge Characteristics—

(1) High-Rate Pulse Discharge Characteristics

The produced dry batteries were discharged at 1.5 W for 2 seconds in a constant temperature atmosphere of 21° C., and then were discharged at 0.65 W for 28 seconds (pulse discharge). This was regarded as one cycle, and 10 cycles of the pulse discharge were performed per hour, and time required until a closed circuit voltage reached 1.05 V was measured. A discharge test of ANSI C18.1M was applied to this evaluation with necessary modifications.

(2) Tapping Discharge Test (Vibration Test)

The produced dry batteries, to each of which a 5.5 Ω resistance was connected, were discharged in a constant temperature atmosphere of 21° C. while tapping impact having a stroke length of 4 cm was exerted on the dry batteries at a frequency of 2 times/minute. Time required until a discharged voltage reached 1.1 V was measured. This is a test to evaluate the stability of the discharge performance of batteries for drop impact and vibration, and the longer the time required is, the higher the degree of stability is.

FIG. 4 shows the results of the evaluation of the batteries according to the first example and the first to third comparative examples. The results of the evaluation are shown with reference to Battery Z of the third comparative example (with reference to the results of Battery Z regarded as 100).

Dry battery A of the first example is significantly improved in high-rate pulse discharge characteristic, and shows excellent results of the vibration test compared to Dry battery Z of the third comparative example. This is because the negative electrode includes a zinc fiber sheet, which improves the high-rate pulse discharge characteristic, and for vibration, electrical connection to the current collector pin is maintained by the gel part. Although the high-rate pulse discharge characteristics of Dry batteries X and Y respectively of the first and second comparative examples are as good as that of the Dry battery A, the vibration test performed on Dry batteries X and Y shows significantly poor results compared to that of Dry battery Z because the current collector pins of Dry batteries X and Y are each simply in contact with the zinc fiber sheet.

### Second Example

Dry batteries of a second example were produced in the same manner as the first example except that the diameter or length of the zinc fiber was changed. FIG. 5 shows the range of the diameter and length of the zinc fiber. FIG. 5 shows the discharge characteristics of Dry batteries B1-B10 of the second example.

In comparison with Dry battery Z of the third comparative example, the high-rate pulse discharge characteristics of Dry batteries B1-B10 and the results of the vibration test performed on Dry batteries B1-B10 are as good as, or better than those of Dry battery Z. In particular, the high-rate pulse discharge characteristic was good when the zinc fiber had a diameter of 50 μm to 500 μm both inclusive, and a length of 10 mm to 300 mm, both inclusive.

### Third Example

Dry batteries of a third example were produced in the same manner as the first example except that the mass of the alkaline electrolyte per dry battery x [g], and the mass of zinc contained in the negative electrode y [g] were varied, while the value x+y was kept uniform. The values x and y were indicated as x/y values in FIG. 6. FIG. 6 shows the discharge characteristics of Dry batteries C1-C5 of the third example.

The value x/y of Dry battery Z of third comparative example was 1.10. When Dry batteries C1-C5 were compared with Dry battery Z, Dry batteries C1-C5 showed improved high-rate pulse discharge characteristics. In particular, the high-rate pulse discharge characteristic was good in the range of 1≦x/y≦1.5. The results of the vibration test performed on the Dry batteries C1-C5 were as good as, or better than that of Dry battery Z.

### Fourth Example

Dry batteries of a fourth example were produced in the same manner as the first example except that the amount of the positive electrode and the amount of the negative electrode per dry battery were varied, while a sum of volumes of the positive and negative electrodes was kept uniform. The amounts of the positive and negative electrodes were varied using, as an index, balance of capacity between the negative electrode and the positive electrode which is calculated on the conditions that MnO₂ contained in the positive electrode has a theoretical capacity of 308 mAh/g, and Zn contained in the negative electrode has a theoretical capacity of 820 mAh/g. The values of balance of capacity between the negative electrode and the positive electrode shown in FIG. 7 indicate the range of variations in the amount of the positive electrode and the amount of the negative electrode. FIG. 7 shows the discharge characteristics of Dry batteries D1-D5 of the fourth example.

The balance of capacity between the negative electrode and the positive electrode of Dry battery Z of the third comparative example was 1.05. In comparison with Dry battery Z, the high-rate pulse discharge characteristics of Dry batteries D1-D5 were as good as, or better than that of Dry battery Z. In particular, the high-rate pulse discharge characteristic was good when the balance of capacity was in the range of 0.9 to 1.1, both inclusive. The results of the vibration test performed on Dry batteries D1-D5 were as good as, or better than that of Dry battery Z.

### Other Embodiments

The above-described embodiment and examples are provided merely for the illustration purpose, and do not limit the present invention. For example, some of the above-described embodiment and/or examples may be combined. For example, the second example and the third example may be combined, or the third example and the fourth example may be combined. Other examples may also be combined.

The zinc fiber sheet may be replaced with the porous zinc body in the form of a ribbon or a foam described in PATENT DOCUMENTS 1 to 3, or a porous zinc body made of compressed fibers, filaments, or strands.

The skeleton part made of a porous zinc body may have a columnar shape having a closed bottom. In this case, the skeleton part may be placed in the battery case with the bottom side down.

In the above-described examples, the zinc fiber sheet is made of pure zinc. However, to prevent corrosion, the zinc fiber sheet may be made of a zinc alloy containing a small amount of indium, bismuth, aluminum, calcium, magnesium, etc.

### INDUSTRIAL APPLICABILITY

The present invention provides an alkaline battery which is improved in pulse discharge characteristic under high load with a stable performance for drop impact, vibration, or the like, and can suitably be applied to digital still cameras, electronic game devices, etc.

### DESCRIPTION OF REFERENCE CHARACTERS

1 Exterior Label
2 Positive Electrode Material Mixture Pellet
3 Negative Electrode
4 Separator
5 Resin Sealing Plate
6 Current Collector Pin
7 Bottom Plate
8 Battery Case
9 Negative Electrode Terminal Structure
11 Skeleton Part
12 Gel Part

1. An alkaline battery comprising:
a hollow cylindrical positive electrode placed in a cylindrical battery case having a closed bottom;
a negative electrode placed in a hollow part of the positive electrode;
a separator arranged between the positive electrode and the negative electrode; and
an alkaline electrolyte, wherein
the negative electrode includes a hollow cylindrical skeleton part made of a porous zinc body, and a gel part which is placed in a hollow part of the skeleton part, and is made of zinc particles and a gelled electrolyte, and
a current collector pin made of metal is inserted in the gel part.

2. The alkaline battery of claim 1, wherein
the skeleton part is formed by winding a porous zinc sheet.

3. The alkaline battery of claim 2, wherein
the porous zinc sheet is made of an aggregate of zinc fibers each having a diameter of 50 μm to 500 μm, both inclusive, and a length of 10 mm to 300 mm, both inclusive.

4. The alkaline battery of claim 3, wherein
the zinc fiber is formed by melt spinning.

5. The alkaline battery of claim 1, wherein
1.0≦x/y≦1.5, where x is total mass of the alkaline electrolyte and the gelled electrolyte [g], and y is mass of zinc contained in the negative electrode [g], is satisfied.

6. The alkaline battery of claim 1, wherein
balance of capacity between the negative electrode and the positive electrode, which is calculated on the conditions that MnO₂ contained in the positive electrode has a theoretical capacity of 308 mAh/g, and Zn contained in the negative electrode has a theoretical capacity of 820 mAh/g, is 0.9 to 1.1, both inclusive.
